(19) United States
(12) Patent Application Publication
(10) Pub. No.: US 2001/0052983 A1
(43) Pub. Date: Dec. 20, 2001

(54) Device for quantitative assessment of the aligned position of two machine parts, workpieces or the like

(76) Inventor: Michael Hermann, Villingen (DE)

Correspondence Address: NIXON PEABODY, LLP, 8180 GREENSBORO DRIVE, SUITE 800, MCLEAN, VA, 22102, US

(21) Appl. No.: 09/817,797

(22) Filed: Mar. 27, 2001

(30) Foreign Application Priority Data
Mar. 27, 2000 (DE) 100 14 772.0

(51) Int. Cl. G01B 11/14

(52) U.S. Cl. 356/614

(57) ABSTRACT

A device for quantitative assessment of the aligned position of two machine parts, workpieces or the like is used especially for purposes of axis alignment or spindle alignment. A light beam is incident on an optoelectronic sensor which can be read out two-dimensionally and the impact point there is determined by the sensor. Part of the light beam is preferably reflected by the sensor directly onto a second optoelectronic sensor. The impact point of the reflected light beam there is determined in a feasible manner by the second sensor. The orientation of at least the first sensor relative to the location of the light beam is determined from the signals of the two sensors.

### BACKGROUND OF THE INVENTION

1. Field of the Invention

The invention relates to a process and related apparatus for assessment of the aligned position of two machine parts, for example, shafts, machine tool spindles, workpieces or the like.

2. Description of Related Art

Processes of the type to which the present invention is directed have been in use for years and are characterized by the saving of much working time by their application. Examples of such processes and devices can be found in German patent applications DE 3473344.2-08, DE 38 14 466 and DE 199 23 116 as well as European Patent Application EP 0183811, in this connection reference should be made to the teaching of.

In German patent applications DE 38 14 466 and DE 199 23 116 it is described how the aligned position of two machine parts, especially of two shafts which are to be connected to one another, or the alignment between a machine spindle and a workpiece, can be checked, assessed and measured using a single, beam-generating light source.

The known devices and processes call for precision parts and components, partially also cost-intensive optical components to enable precise and reliable measurements. Since, as mentioned, the advantages of the known systems are considerable, the relatively high production costs of the known devices of this type are accepted by most potential users.

### SUMMARY OF THE INVENTION

The object of the present invention is to improve the known processes on the hardware side in order to achieve much lower production costs for the devices, and so that they can also be used in environments where, for reasons of costs, this was either not possible in the past, or in any case, was hesitatingly accepted.

This object is achieved by devising a device for quantitative assessment of the alignment position of two machine parts, workpieces or the like, especially for purposes of axis alignment or spindle alignment, which makes the use of separate optical elements (reflectors, prisms, lenses) superfluous for the most part, and thus, leads to major cost savings.

According to the approach according to the invention, the fact is used that the surface of position detectors, as are known from the cited application documents, in the current embodiment is of a very well suited flat structure, and thus, actually cannot distinguish the additional function which is not provided, but still present, as a mirror with a defined reflectivity. Furthermore, the approach as in accordance with the invention uses the fact that the energy load capacity of modem position detectors, especially in the form of CMOS sensors, has been greatly increased so that relatively high maximum intensity or radiation density on the sensor can be allowed. The use of this circumstance in the invention thus makes superfluous at least one optical precision component and its installation costs, for example, calibration efforts, verification of operation, quality control in procurement, etc. For this reason, a device can be provided which is characterized by a clearly reduced component cost, can be more economically produced, and thus, can be used in many other applications, especially now also in the checking of the alignment of machine tools, their spindles or their tools.

Accordingly, the invention provides a device for measuring or evaluating the relative position of two machine parts, tools or workpieces, which is characterized in that, in combination, there is the following:

a means for producing one or more masked light beams,

one optoelectronic sensor of a first type and at least one optoelectronic sensor of a second type which can be read out two-dimensionally and is preferably pixel-oriented,

relative alignment of two-dimensionally acting optoelectronic sensors of the first and the second type with respect to one another such that an incident masked light beam is reflected by the surface of an optoelectronically active layer, optionally by a specular layer of a pertinent cover glass, of the optoelectronic sensors of the first type, proportionally and essentially directly in the form of a first and optionally other light beams onto the optoelectronic sensor(s) of the second type, and

electronics or a computer which accepts the output signals delivered by the optoelectronic sensors, processes them, and computes the relative position of the means relative to the incident masked light beam.

The invention is explained in greater below with reference to the accompanying drawings.

### BRIEF DESCRIPTION OF THE DRAWINGS

FIG. 1 shows a known arrangement of sensors for ascertaining the relative position of the reference axis of an object with respect to a reference beam according to the prior art;

FIG. 2 shows another known arrangement for ascertaining the relative position of the reference axis of an object with respect to a reference beam, according to the prior art, with a single, double-acting position sensor which can read out two-dimensionally;

FIG. 3 shows an arrangement of sensors in accordance with the invention for ascertaining the relative position of the reference axis of an object with respect to a reference beam, for example for assessing the aligned position of two machine parts, tools, or workpieces;

FIG. 4 shows another arrangement of sensors and the incident light beam in accordance with the invention;

FIG. 5 shows third embodiment in accordance with the invention.

### DETAILED DESCRIPTION OF THE INVENTION

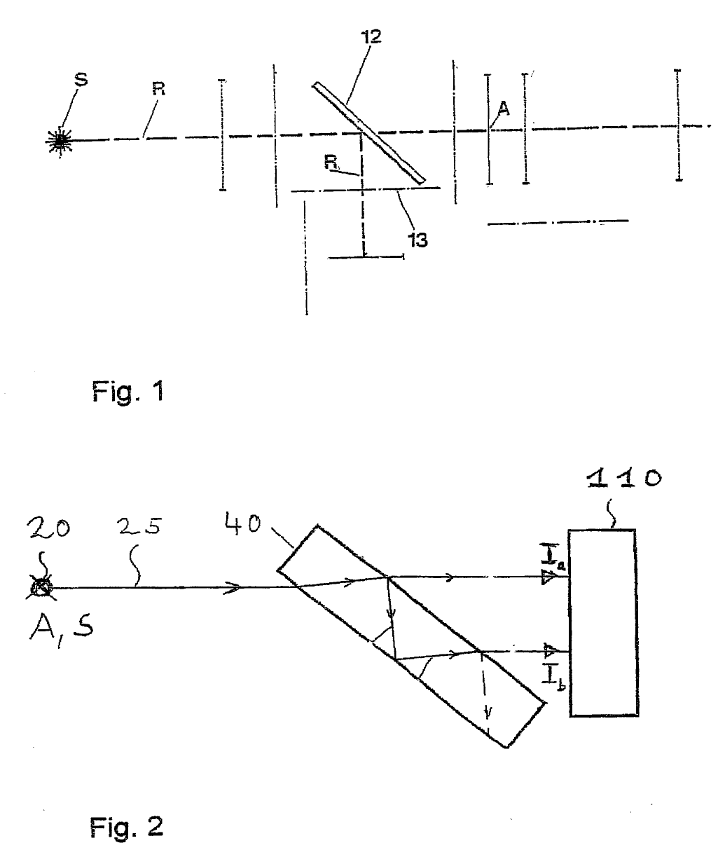

As shown in FIG. 1 and is known from the pertinent patent literature, a single light beam R and two optoelectronic position detectors which can be read-out two dimensionally, A and A', can be used to determine the relative reference axis of an object with respect to the light beam R. This can be used, for example, to very accurately determine the relative position of two shaft pieces, or a machine tool spindle relative to a workpiece. Typically, several measurements are taken in order to obtain more accurate or reliable characteristic values using a set of measurement data, which values can also be subject to subsequent data processing. It is important that the indicated arrangement can determine not only the parallel offset (according to two translational coordinates), but also the angular offset of the reference axis, and this, according to two angle coordinates of space.

A similarly acting arrangement is shown in FIG. 2; however, it has two specular or partially specular surfaces, for this reason, instead of two separate sensors there is now a single sensor 110 which has a double-acting function. With this arrangement, the reference axis can be determined relative to an incident light beam according to a total of four coordinates, specifically two translational coordinates and two angular coordinates. It can be understood that high demands must be imposed on the precision of the multiple reflectors 40 shown.

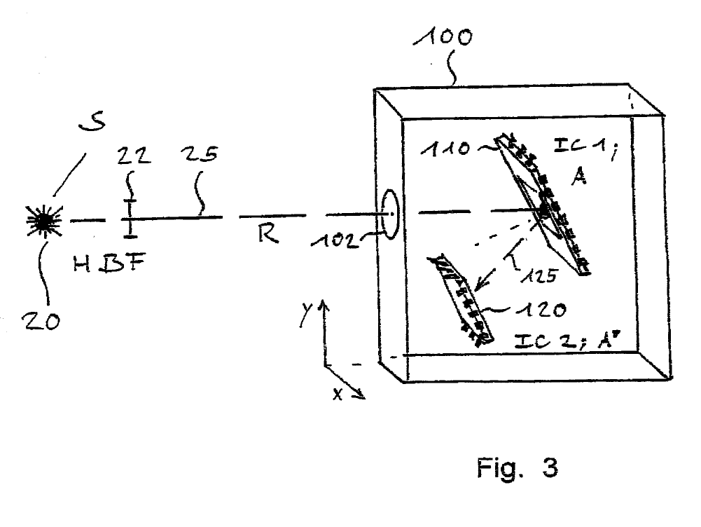

As shown in FIG. 3, in accordance with the invention, it is now also possible to eliminate the multiple reflector 40 which is shown in FIG. 2 or the semi-transparent mirror 12 which is shown in FIG. 1. This takes place by the two-dimensionally sensitive optoelectronic sensor 110 (at coordinates IC1; A) which can be read out being allowed to receive the impact point of a light beam R, 25, not only with its light-sensitive layer in the conventional manner, but moreover, its very flat surface being used to reflect a portion of the incident light beam R, 25. The reflected portion 125 is, depending on the surface quality, roughly 2 to 10% of the incident light, and at the current quality of the detectors used, is sufficient to adequately and effectively illuminate a second optoelectronic sensor 120 (at coordinates IC2, A'). The latter can therefore execute further position determination of the incident light beam, as is necessary in the known approach. The optoelectronic sensors 110, 120 are CMOS sensor circuits (ICs) which are irradiation-insensitive, but moreover highly sensitive and highly dynamic. A preferred IC component is of the type HCDS-2000 that is available from HP/Agilent, with a diagonal of the sensitive surface of roughly 8 mm. If a surface of the optoelectronic sensors with larger dimensions is necessary, one can be chosen of the type that is used in current so-called digital cameras. These modules are characterized by higher relative resolution, but are however much more expensive than the surprisingly economical components from Agilent.

As follows from FIG. 3, a laser light source S, reference number 20, can emit a laser beam 25 which can pass through a very economical holographic beam former (HBF) 22 to improve beam quality. The laser light source 20 is located typically in a separate housing and is preferably connected to a first machine part. The optical sensors 110, 120 are advantageously located fixed in a housing 100 which is preferably connected to the second machine part. The laser beam 25, however, enters the housing 100 through an aperture, for example, a protective glass or film 102, and can act directly on the optical sensor 110.

The signals delivered by the optoelectronic sensors can be further processed in the conventional manner by means of a suitable computer and the pertinent software; this will not be explained in particular here for the sake of brevity. The advantage known from FIG. 2, i.e., the ability to display the position and the intensity ratios of the laser beams incident on the optoelectronic sensors directly via the display of a portable computer, can also be obtained with this invention. It goes without saying that, within the framework of the further computer processing of the signals acquired by the sensors, aspects of remote interrogation and so-called “networking” can be also treated and resolved.

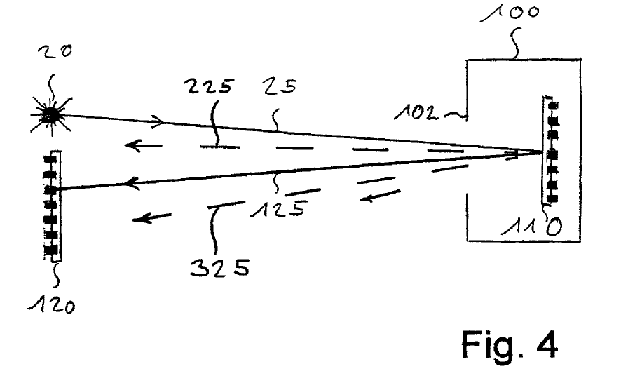

The embodiment of the invention shown in FIG. 4 increases the attainable angular resolution of the arrangement. This embodiment is preferred when the angular deviations to be studied are in the area of angular minutes. This is always the case when especially high demands are imposed on the parallelism of the machine parts to be aligned. The desired greater angular resolution is achieved by the relative remote arrangement of the optoelectronic sensor 120 with respect to the sensor 110 without the resolution being reduced with respect to the parallel displacements (offset). The aperture 102 can be made in the case of the embodiment as shown in FIG. 4 as a partially transmitting mirror; this however, dictates additional costs and is an obstacle to the desired, most economical solution. But, the advantage arises that the intensity of the received light beams is roughly the same on both optoelectronic sensors.

As shown in FIG. 4, it is also possible to use the properties of a pixel-oriented sensor which are diffractive in reflection (diffraction on two-dimensional gratings of the pixels) when such a sensor is being used. Accordingly, in addition to the light beam 125 which is reflected in a so-called zeros order of diffraction, also the simultaneously arising secondary beams 225, 325, etc. of the 1^{st}, 2^{nd}, 3^{rd} etc. order of diffraction are imaged and evaluated, either likewise on the sensor 120, or on one or more such sensors which are not shown in FIG. 4 for reasons of clarity. The principle shown in FIG. 4, i.e., to use several reflected beams (125, 225, 325) for measuring the relative orientation of the sensors, and thus of the means 100 relative to the sensor 120, can feasibly be used in an arrangement as shown in FIG. 3.

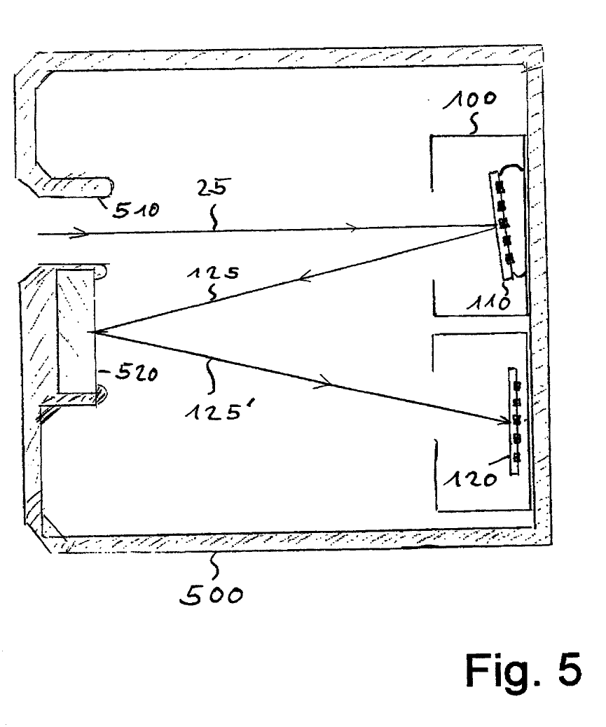

FIG. 5 shows one modification of the construction as shown in FIG. 4. Here, the beam 125 is folded by means of a reflector 520 so that a shortened structural shape is available for the desired high angular resolution. In addition, the sensors 110, 120 are in the spatial vicinity of each other, so that, in this respect, questions of cabling and signal transmission can be simplified. If necessary, the sensors 110, 120 can even be monolithically combined.

As follows from FIG. 5, within a surrounding housing 500, on its inner back wall, there are sensors 110, 120. The sensor 110 is mounted roughly angled. A light beam 25 which is incident in the surrounding housing through the opening 510 is thus reflected by the proportionably reflecting surface of the sensor 110 onto the reflector 520 in order to travel from there, as the beam 125′, to the sensor 120. Thus, this sensor arrangement is suitable for determining an incident light beam with respect to its relative position with reference to the dimensions of the housing 500 according to two translational coordinates. Furthermore, this sensor arrangement is likewise suited for determining the direction of the incident light beam according to two angular coordinates relative to the axis of symmetry of the housing 500, only one additional optical element in the form of a reflector being necessary.

If, in addition, there is a beam 25 of asymmetrical cross sectional shape, moreover, identification of the rotational position (“roll” coordinate) of the housing 500 is possible relative to one axis of rotation which is defined by the light beam.

In one modification of the invention, also optoelectronic sensors of varied technology can be used so that, for example, the sensor 100 can be pixel-oriented and sensor 120 can be of a second type which can determine only the centroidal location of an incident family of light beams.

The invention in the embodiment as shown in FIG. 5 is specially suited for use as an optical receiving unit for the position detection system German Patent Application DE 19733919 and U.S. Pat. No. 6,049,378.

The embodiment shown is so economical and requires so little electricity that it can optionally be installed permanently on rotating shafts. For this purpose, it is advantageous to provide a energy supply which works without contact and signal decoupling for the electronic components used.

What is claimed is:

1. Device for measuring or evaluating the relative position of two elements with respect to each other, comprising:
a light source for producing at least one masked light beam;
a first two-dimensionally readable optoelectronic sensor and at least one second two-dimensionally readable optoelectronic sensor which are in a relative alignment with respect to each other such that a masked light beam incident on a surface of an optoelectronically active layer of the first optoelectronic sensor is reflected by the surface proportionally and essentially directly as a light beam onto a surface of the at least one second two-dimensionally readable optoelectronic sensor;
electronic means for receiving output signals from the optoelectronic sensors, processing the signals, and computing the relative position of the electronic means relative to the incidences of the at least one masked light beam on the surfaces of the two-dimensionally readable optoelectronic sensors.

2. Device for measuring or evaluating the relative position of two elements with respect to each other, comprising:
a light source for producing at least one masked light beam along a beam path;
a first two-dimensionally readable optoelectronic sensor and a second two-dimensionally readable optoelectronic sensor;
a partially transmitting mirror which is located in the beam path in front of the first optoelectronic sensor which can be read out two-dimensionally, the mirror and the sensors being in a relative alignment with respect to each other such that a masked light beam incident on a surface of an optoelectronically active layer of the first optoelectronic sensor is reflected by the mirror proportionally and essentially directly as a light beam onto a surface of the second two-dimensionally readable optoelectronic sensor;
electronic means for receiving output signals from the optoelectronic sensors, processing the signals, and computing the relative position of the at least one masked light beam relative to the first two-dimensionally readable optoelectronic sensor.

3. Device for measuring or evaluating the relative position of two elements with respect to each other, comprising:
a light source for producing at least one masked light beam;
a first two-dimensionally readable optoelectronic sensor and at least one second two-dimensionally readable optoelectronic sensor;
a housing in which the first and second two-dimensionally acting optoelectronic sensors a positioned relative to one another such that an masked light beam incident on first two-dimensionally readable optoelectronic sensor is proportionally reflected as a plurality of light beams in a folded beam path by a surface of an optoelectronically active layer of the first optoelectronic sensor onto the optoelectronic sensor;
electronic means for receiving output signals from the optoelectronic sensors, processing the signals, and computing the relative position of the housing relative to the incidences of the at least one masked light beam on the surfaces of the two-dimensionally readable optoelectronic sensors.
electronics or a computer which accepts the output signals delivered by the optoelectronic sensors, processes them, and computes the position of the housing relative to the incidences of the at least one masked light beam on the surfaces of the two-dimensionally readable optoelectronic sensors.
